(19) United States
(12) Patent Application Publication
(10) Pub. No.: US 2023/0281265 A1
(43) Pub. Date: Sep. 7, 2023

(54) METHOD FOR ESTIMATING BODY SIZE AND WEIGHT OF PIG BASED ON DEEP LEARNING

(71) Applicant: SOUTH CHINA AGRICULTURAL UNIVERSITY, Guangdong (CN)

(72) Inventors: Deqin XIAO, Guangdong (CN); Junbin LIU, Guangdong (CN); Youfu LIU, Guangdong (CN); Qiumei YANG, Guangdong (CN); Yigui HUANG, Guangdong (CN); Wentao YANG, Guangdong (CN); Shengqiu ZHAO, Guangdong (CN); Zhiyi BIAN, Guangdong (CN)

(73) Assignee: SOUTH CHINA AGRICULTURAL UNIVERSITY, Guangdong (CN)

(21) Appl. No.: 17/775,590

(22) PCT Filed: Dec. 30, 2021
(86) PCT No.: PCT/CN2021/142936

§ 371 Date: May 10, 2022

(30) Foreign Application Priority Data
Oct. 13, 2021 (CN) 202111194639.4

(51) Int. Cl. G06F 17/10; G06F 18/20; G06N 3/08

(52) U.S. Cl. CPC G06F 17/10; G06F 18/285; G06N 3/08

(57) ABSTRACT

The present disclosure provides a method for estimating a body size and weight of a pig based on deep learning, and relates to the technical field of deep learning. The present disclosure predicts the weight of the pig by using a convolutional neural network. Relevant features are learned by the convolutional neural network, and feature engineering extraction is not needed to be established, so that extracted features are more comprehensive, and the convolutional neural network is superior to a linear model in processing of noisy data and nonlinear problems of data. Images of the pig are shot by an ordinary two-dimensional (2d) color camera.

### TECHNICAL FIELD

The present disclosure relates to the technical field of deep learning, and more particularly, to a method for estimating a body size and weight of a pig based on deep learning.

### DESCRIPTION OF RELATED ART

The pig industry is a part of important agricultural economy in China. China is an important pork producer and consumer in the world, with a pork output of 41.13 million tons in 2020, accounting for more than 50% of a global pork output. With the technological development of artificial intelligence, the development of large-scale, precise and intelligent animal husbandry has been promoted. Therefore, precise measurement of individual pigs may increase the breeding scale of animal husbandry, reduce labor costs and enhance the production efficiency.

Body size and weight of pigs are important indicators to determine body conditions of the pigs. Changes in weight and body size provide a direct means of evaluating health and growth conditions of the pigs. The weight and body size of the pigs are also very important indicators in terms of pig breeding, meat quality evaluation, feeding management, and disease detection.

At present, the body size and weight of the pigs are mainly measured manually. A traditional measurement method requires a lot of time and manpower and is inefficient, and it is easy to stimulate pig bodies, which is not conducive to pig welfare. In recent years, deep learning has developed rapidly and has achieved remarkable performance in complex tasks such as face recognition and object detection. However, these technologies are not widely used in precision agriculture, especially in the estimation of the weight and body sizes of animals. Existing algorithms for estimating a body size and weight of a pig based on computer vision technology are not well combined with deep learning methods.

According to a method, an apparatus and a device for estimating the weight of livestock and a computer-readable storage medium, with publication number: CN111243005A and publication date of 2020 Jun. 5, this invention, by using a point cloud technology in a depth image, gradually locks target livestock in scattered point clouds from a top-down perspective to construct a point cloud set of the livestock, screens out specific body size information and then inputs a linear regression model to estimate the weight, but this method is prone to missing features, and traditional linear regression models are inferior to the deep learning methods in processing noisy data and dealing with nonlinear problems between variables.

### SUMMARY

To solve the above technical problems, the present disclosure provides a method for estimating a body size and weight of a pig based on deep learning, which is rich in features and has a better effect of dealing with nonlinear problems.

The present disclosure has the following technical solution:

A method for estimating a body size and weight of a pig based on deep learning, including the following steps:
S1, obtaining images of the pig;
S2, detecting, by using a keypoint detection algorithm, keypoints of the pig in the images to obtain a keypoint detection result, and removing images that the pig is incomplete in a screen and retaining images that the pig is complete in the screen according to the keypoint detection result;
S3, detecting whether the pig is slanted in the screen, and correcting the screen of the slanted pig to obtain images that the pig is complete and not slanted in the screen; and
S4, inputting the images into a weight estimation model and calculating body size data according to the keypoint detection result to obtain the weight and body size data of the pig,
wherein the keypoint detection algorithm in the step S2 is built based on a Keypoint-Recurrent Convolutional Neural Network (Keypoint-RCNN) algorithm, the weight estimation model in the step S4 is built based on a ResNext-101 feature extraction network, and the Keypoint-RCNN algorithm is added with a keypoint branch on the basis of a Mask-RCNN, and a feature extraction network of the Keypoint-RCNN algorithm adopts the ResNext-101 feature extraction network;
and the weight estimation model in the step S4 uses the ResNext-101 feature extraction network.

This technical solution provides a method for estimating a body size and weight of a pig based on deep learning. The weight of the pig is predicted by using a convolutional neural network. Relevant features are learned by the convolutional neural network, and feature engineering extraction is not needed to be established, so that extracted features are more comprehensive, and the convolutional neural network is superior to a linear model in the processing of noisy data and nonlinear problems of data.

Further, in the step S2, by using an instance segmentation algorithm, the images are subjected to instance segmentation first before the keypoints are detected, and pixels belonging to the pig in the images are marked; the instance segmentation algorithm is built based on a Mask RCNN instance segmentation network; and an instance segmentation process includes:
first, inputting the images into the ResNext-101 feature extraction network in the Mask RCNN instance segmentation network to obtain a feature map;
then, setting a fixed number of regions of interest for each pixel position of the feature map, inputting the regions of interest into a region proposal network in the Mask RCNN instance segmentation network to perform binary classification to obtain a foreground and a background, and performing coordinate regression, so as to obtain high-quality regions of interest;
next, performing ROIAligin operation on the obtained regions of interest, namely, establishing a correspondence between pixels of the original images and the feature map first and then establishing a correspondence between the feature map and fixed features; and
finally, classifying the regions of interest in a fully connected layer, generating detection boxes of detected objects in the regions of interest, and performing regression on the regions of interest to make the detection boxes gradually approach correct positions of the detected objects, and performing segmentation in a fully convolutional layer, so as to finally obtain a result of instance segmentation.

Further, in the step S2, the keypoints are detected after the instance segmentation, and the keypoint detection algorithm is built based on the Keypoint-RCNN algorithm; the keypoint detection algorithm is configured to detect and mark the keypoints, the position of each keypoint is modeled as a separate one-hot mask, each type of keypoint has a mask, and only one pixel, for each keypoint, is marked as the foreground; and

the keypoints obtained by segmentation include: a left ear root point, a right ear root point, a left front elbow point, a right front elbow point, a left rear elbow point, a right rear elbow point, a spinal back point, and a tail root point.

Further, in the step S4, the weight estimation model is built based on the ResNext-101 feature extraction network, and a softmax layer for modifying the ResNext-101 feature extraction network is a fully connected layer, with an output quantity of 1.

Further, the weight estimation model is subject to model training after being built; and a training process is as follows: first, preparing a training data set including a plurality of the images of the pig and the weight of the pig corresponding to each image, segmenting the pig of each image in the training data set, and binarizing the images to obtain binarized images of the pig and the weight of the pig corresponding to the images; and then, dividing the training data set into a training set, a test set and a validation set according to a ratio of 6:2:2, first inputting the training set into the weight estimation model to perform model training to determine model parameters, then testing, by the test set, an estimation accuracy of the weight estimation model, and finally inputting the validation set into the weight estimation model to further adjust the model parameters, so as to obtain a trained weight estimation model.

Further, estimating, by the trained weight estimation model, the weight by the images of the pig includes: inputting the images of the pig with the weight to be estimated into the weight estimation model, extracting, by a convolutional layer, features of the images to obtain the image features, and inputting the image features into the fully connected layer to finally output the estimated weight.

Further, in the step S4, the body size data includes: a shoulder width, a hip width, and a body length, and the body size data is calculated according to a distance between the keypoints.

Further, in the step S3, the correcting is to correct the slanted pig with a minimum circumscribed rectangle.

Further, in the step S4, the body size data and the weight data of the pig are bound with an identity of the pig and stored after being estimated, and the identity of the pig is obtained by recognizing back features of the pig in the images.

Further, the weight estimation model includes a loss function, and the loss function uses a root mean square error function.

This technical solution provides a method for estimating a body size and weight of a pig based on deep learning. Compared with the prior art, the technical solution of the present disclosure has the following beneficial effects: the weight of the pig is predicted by using a convolutional neural network. Relevant features are learned by the convolutional neural network, and feature engineering extraction is not needed to be established, so that extracted features are more comprehensive, and the convolutional neural network is superior to a linear model in the processing of noisy data and nonlinear problems of data.

### BRIEF DESCRIPTION OF THE DRAWINGS

FIG. 1 is a flowchart of image screening and correction;

FIG. 2 is a schematic diagram of a pig shot by a camera;

FIG. 3 is a network structure diagram of instance segmentation algorithm; and

FIG. 4 is a network structure diagram of keypoint detection algorithm.

### DESCRIPTION OF THE EMBODIMENTS

To clearly describe a method for estimating a body size and weight of a pig based on deep learning in the present disclosure, the present disclosure is further described with reference to the embodiments and accompanying drawings, but this should not limit the scope of protection of the present disclosure.

### Embodiment 1

A method for estimating a body size and weight of a pig based on deep learning, including the following steps:
S1, images of the pig were obtained;
S2, keypoints of the pig in the images, by using a keypoint detection algorithm, were detected to obtain a keypoint detection result, and images that the pig was incomplete in a screen were removed and images that the pig was complete in the screen were retained according to the keypoint detection result;
S3, whether the pig was slanted was detected in the screen, and the screen of the slanted pig were corrected to obtain images that the pig was complete and not slanted in the screen; and
S4, the images were input into a weight estimation model and body size data was calculated according to the keypoint detection result to obtain the weight and body size data of the pig.

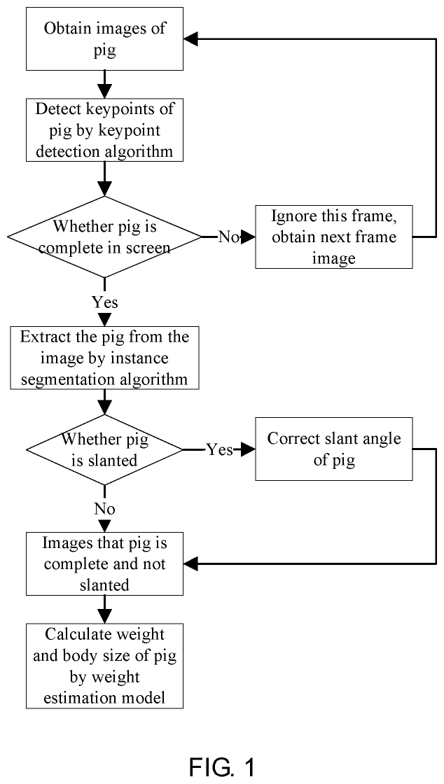

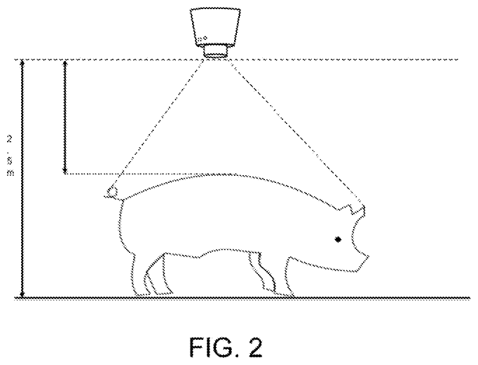

FIG. 1 is a flowchart of image screening and correction corresponding to the steps S1 to S3. The images of the pig in the step S1 were ordinary planar images shot by an ordinary two-dimensional (2d) color camera. The pig shot by the 2d color camera in this embodiment is as shown in FIG. 2. A pig passage built with iron railings was installed in the middle of a passage for the pig to enter a rest area. The entrance and exit of the passage were designed to allow only one-way passing, thereby ensuring that only one pig might pass through the passage at a time. The 2d color camera was installed above the passage and capable of shooting the back and hip of the pig. The keypoints of the body size, such as a left ear root point, a right ear root point, a left front elbow point, a right front elbow point, a left rear elbow point, a right rear elbow point, a spinal back point, and a tail root point, might be observed.

The images of the pig shot by the camera were sent to the keypoint detection algorithm in the form of a red, green and blue (RGB) video. The keypoint detection algorithm adopted a Keypoint-RCNN algorithm and was configured to detect the keypoints of received video frames. Whether the pig in the images was complete was judged according to the keypoint detection result. If the pig was not complete, the current frame image was removed, and the next frame image was obtained. If the pig in the images was complete, it was judged whether a pig's angle was standard and that the pig was not slanted. If the pig's angle was standard, the images of the pig were judged to be qualified images of the pig. If the pig was slanted, a slant angle of the pig in the images was corrected to obtain the qualified images of the pig.

In particular, the Keypoint-RCNN algorithm was added with a keypoint branch on the basis of a Mask-RCNN, and a feature extraction network of the Keypoint-RCNN algorithm adopted an ResNext-101 feature extraction network; and

the weight estimation model in the step S4 used the ResNext-101 feature extraction network.

This embodiment disclosed a method for estimating a body size and weight of a pig based on deep learning. The weight of the pig was predicted by using a convolutional neural network. Relevant features were learned by the convolutional neural network, and feature engineering extraction was not needed to be established, so that extracted features were more comprehensive, and the convolutional neural network was superior to a linear model in processing of noisy data and nonlinear problems of data. According to this technical solution, the images of the pig were shot by the 2d color camera that was cheap. This technical solution might be implemented cost-effectively.

### Embodiment 2

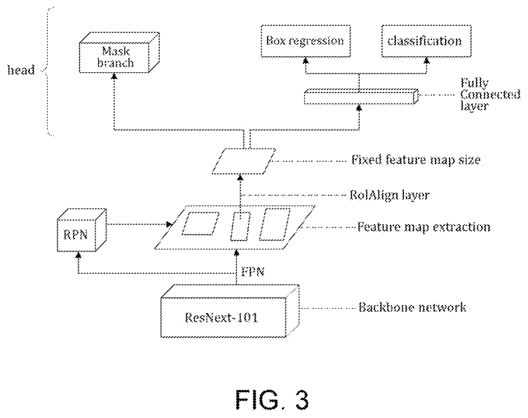

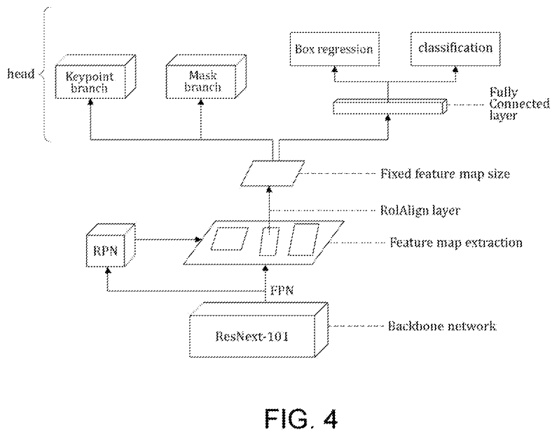

A method for estimating a body size and weight of a pig based on deep learning, including the following steps:
S1, images of the pig were obtained;
S2, by using an instance segmentation algorithm built based on a Mask RCNN instance segmentation network, the images were subjected to instance segmentation, pixels belonging to the pig in the images were marked, keypoints of the pig in the images, by using a keypoint detection algorithm, were detected, and images that the pig was incomplete in a screen were removed and images that the pig was complete in the screen were retained according to a keypoint detection result,
wherein a network structure diagram of instance segmentation algorithm was as shown in FIG. 3, and an instance segmentation process included:
first, the images were input into an ResNext-101 feature extraction network in a Mask RCNN instance segmentation network to obtain a feature map;
then, a fixed number of regions of interest were set for each pixel position of the feature map, the regions of interest were input into a region proposal network in the Mask RCNN instance segmentation network to perform binary classification to obtain a foreground and a background, and coordinate regression was performed, so as to obtain high-quality regions of interest;
next, ROIAligin operation was performed on the obtained regions of interest, and an ROIAligin operation process was as follows: corresponding parts, for the input regions of interest (ROI), were extracted from the feature map, then the regions of interest (ROI) on the feature map were divided into regions of equal size, each region was sampled, coordinates of sampling points were obtained by bilinear interpolation according to coordinates of cells where the sampling points are located, and then maxpooling was performed on the obtained sampling points to obtain a final output; and
finally, the regions of interest were classified in a fully connected layer, detection boxes of detected objects were generated in the regions of interest, and regression on the regions of interest was performed to make the detection boxes gradually approach correct positions of the detected objects, and segmentation was performed in a fully convolutional layer, so as to finally obtain a result of instance segmentation;
in the actual application process of this embodiment, the instance segmentation algorithm ran in a server. After each instance segmentation, the images of the pig of multiple video key frames would be retained in the server. The instance segmentation algorithm was subsequently optimized by using the retained video key frames. These key frames were added to a training data set to continue training the instance segmentation algorithm to improve the robustness of the instance segmentation network;
a network structure diagram of keypoint detection algorithm was as shown in FIG. 4. In the step S2, the keypoints were detected after the instance segmentation, and the keypoint detection algorithm was built based on a Keypoint-RCNN algorithm; the keypoint detection algorithm was configured to detect and mark the keypoints, the position of each keypoint was modeled as a separate one-hot mask, each type of keypoint had a mask, and only one pixel, for each keypoint, was marked as a foreground; and
the keypoints obtained by segmentation included: a left ear root point, a right ear root point, a left front elbow point, a right front elbow point, a left rear elbow point, a right rear elbow point, a spinal back point, and a tail root point;
S3, whether the pig was slanted was detected in the images, and the screen of the slanted pig were corrected to obtain images that the pig was complete and not slanted in the screen; and
S4, the images were input into a weight estimation model and body size data was calculated according to the keypoints to obtain the weight and body size data of the pig.

FIG. 1 is a flowchart of image screening and correction corresponding to the steps S1 to S3. The images of the pig in the step S1 were ordinary planar images shot by a 2d color camera. The pig shot by the 2d color camera in this embodiment is as shown in FIG. 2. A pig passage built with iron railings was installed in the middle of a passage for the pig to enter a rest area. The entrance and exit of the passage were designed to allow only one-way passing, thereby ensuring that only one pig might pass through the passage at a time. The 2d color camera was installed above the passage and capable of shooting the back and hip of the pig. The keypoints of the body size, such as the left ear root point, the right ear root point, the left front elbow point, the right front elbow point, the left rear elbow point, the right rear elbow point, the spinal back point, and the tail root point, might be observed.

The images of the pig shot by the camera were sent to the keypoint detection algorithm in the form of an RGB video. The keypoint detection algorithm adopted the Keypoint-RCNN algorithm and was configured to detect the keypoints of the received video frames. Whether the pig in the images was complete was judged according to the keypoint detection result. If the pig was not complete, the current frame image was removed, and the next frame image was obtained. If the pig in the images was complete, it is judged whether a pig's angle was standard and that the pig was not slanted. If the pig's angle is standard, the images of the pig were judged to be qualified images of the pig. If the pig was slanted, a slant angle of the pig in the images was corrected to obtain the qualified images of the pig. In this embodiment, the correcting was to correct the slanted pig with a minimum circumscribed rectangle.

The keypoint detection algorithm adopted the Keypoint-RCNN algorithm, the Keypoint-RCNN algorithm was added with a keypoint branch on the basis of a Mask-RCNN, and a feature extraction network of the Keypoint-RCNN algorithm adopted the ResNext-101 feature extraction network; and

and the weight estimation model in the step S4 used the ResNext-101 feature extraction network. In addition, a softmax layer for modifying the ResNext-101 feature extraction network was the fully connected layer, with an output quantity of 1. A loss function of the weight estimation model used a mean square root error function.

The weight estimation model was subject to model training after being built; and a training process was as follows: first, a training data set including a plurality of the images of the pig and the weight of the pig corresponding to each image was prepared, the pig of each image in the training data set was segmented, and the images were binarized to obtain binarized images of the pig and the weight of the pig corresponding to the images; and then, the training data set was divided into a training set, a test set and a validation set according to a ratio of 6:2:2, first the training set was input into the weight estimation model to perform model training to determine model parameters, then an estimation accuracy of the weight estimation model, by the test set, was tested, and finally the validation set was input into the weight estimation model to further adjust the model parameters, so as to obtain a trained weight estimation model. During the image processing, a convolutional neural network not only greatly reduced neural network parameters, but solved parameter redundancy of a fully connected network. Meanwhile, the introduction of convolution effectively improved the feature extraction ability of the convolutional neural network for the images. Feature engineering was not needed to be established. The convolutional neural network was also superior to a traditional linear model in processing of noisy data and nonlinear problems of data. In this embodiment, the training data set included 3000 images of the pig in total.

The step of estimating, by the trained weight estimation model, the weight by the images of the pig included: the images of the pig with the weight to be estimated were input into the weight estimation model, features of the images, by a convolutional layer, were extracted to obtain the image features, and the image features were input into the fully connected layer to finally output the estimated weight.

In the step S4, the body size data included: a shoulder width, a hip width, and a body length, and the body size data was calculated according to a distance between the keypoints. The shoulder width was a distance between the two keypoints, namely, the left front elbow point and the right front elbow point, the hip width was a distance between the two keypoints, namely, the left rear elbow point and the right rear elbow point, and the body length was a distance from a midpoint of the left ear root point and the right ear root point to the tail root point.

In the step S4, the body size data and the weight data of the pig were bound with an identity of the pig and stored after being estimated, and the identity of the pig was obtained by recognizing back features of the pig in the images.

This embodiment disclosed a method for estimating a body size and weight of a pig based on deep learning. The weight of the pig was predicted by using a convolutional neural network. Relevant features were learned by the convolutional neural network, and feature engineering extraction was not needed to be established, so that extracted features were more comprehensive, and the convolutional neural network was superior to a linear model in processing of noisy data and nonlinear problems of data.

According to this technical solution, the images of the pig were shot by the 2d color camera that was cheap. This technical solution might be implemented cost-effectively. In addition, the keypoints on the pig were obtained by using the keypoint detection algorithm, which reduced a complicated calculation of setting coordinate axes on the images to find the keypoints by gradient or according to geometric features in the past, might efficiently calculate the body size of the pig, and extracted the keypoints in an end-to-end manner.

1. A method for estimating a body size and weight of a pig based on deep learning, the method comprising the following steps:
S1, obtaining images of the pig;
S2, detecting, by using a keypoint detection algorithm, keypoints of the pig in the images to obtain a keypoint detection result, and removing images that the pig is incomplete in a screen and retaining images that the pig is complete in the screen according to the keypoint detection result;
S3, detecting whether the pig is slanted in the screen, and correcting the screen of the slanted pig to obtain images that the pig is complete and not slanted in the screen; and
S4, inputting the images into a weight estimation model and calculating body size data according to the keypoint detection result to obtain the weight and body size data of the pig,
wherein the keypoint detection algorithm in the step S2 is built based on a Keypoint-Recurrent Convolutional Neural Network (Keypoint-RCNN) algorithm, the weight estimation model in the step S4 is built based on a ResNext-101 feature extraction network, and the Keypoint-RCNN algorithm is added with a keypoint branch on the basis of a Mask-RCNN, and a feature extraction network of the Keypoint-RCNN algorithm adopts the ResNext-101 feature extraction network;
and the weight estimation model in the step S4 uses the ResNext-101 feature extraction network.

2. The method according to claim 1, wherein in the step S2, by using an instance segmentation algorithm, the images are subjected to instance segmentation before the keypoints are detected, and pixels belonging to the pig in the images are marked; the instance segmentation algorithm is built based on a Mask RCNN instance segmentation network; and an instance segmentation process comprises:
inputting the images into the ResNext-101 feature extraction network in the Mask RCNN instance segmentation network to obtain a feature map;
setting a fixed number of regions of interest for each pixel position of the feature map, inputting the regions of interest into a region proposal network in the Mask RCNN instance segmentation network to perform binary classification to obtain a foreground and a background, and performing coordinate regression, so as to obtain high-quality regions of interest;
performing ROIAlign operation on the obtained regions of interest, namely, first establishing a correspondence between pixels of the original images and the feature map and then establishing a correspondence between the feature map and fixed features; and
classifying the regions of interest in a fully connected layer, generating detection boxes of detected objects in the regions of interest, and performing regression on the regions of interest to make the detection boxes gradually approach correct positions of the detected objects, and performing segmentation in a fully convolutional layer to finally obtain a result of instance segmentation.

3. The method according to claim 2, wherein in the step S2, the keypoints are detected after the instance segmentation, and the keypoint detection algorithm is built based on the Keypoint-RCNN algorithm; the keypoint detection algorithm is configured to detect and mark the keypoints, position of each keypoint is modeled as a separate one-hot mask, each type of keypoint has a mask, and only one pixel for each keypoint is marked as the foreground; and
the keypoints obtained by segmentation comprise: a left ear root point, a right ear root point, a left front elbow point, a right front elbow point, a left rear elbow point, a right rear elbow point, a spinal back point, and a tail root point.

4. The method according to claim 1, wherein in the step S4, the weight estimation model is built based on the ResNext-101 feature extraction network, and a softmax layer for modifying the ResNext-101 feature extraction network is a fully connected layer, with an output quantity of 1.

5. The method according to claim 4, wherein the weight estimation model is subject to model training after being built; and a training process is as follows:
preparing a training data set comprising a plurality of the images of the pig and the weight of the pig corresponding to each image, segmenting the pig of each image in the training data set, and binarizing the images to obtain binarized images of the pig and the weight of the pig corresponding to the images; and
dividing the training data set into a training set, a test set and a validation set according to a ratio of 6:2:2, inputting the training set into the weight estimation model to perform model training to determine model parameters, then testing, by the test set, an estimation accuracy of the weight estimation model, and finally inputting the validation set into the weight estimation model to further adjust the model parameters, so as to obtain a trained weight estimation model.

6. The method according to claim 5, wherein estimating, by the trained weight estimation model, the weight by the images of the pig comprises: inputting the images of the pig with the weight to be estimated into the weight estimation model, extracting, by a convolutional layer, features of the images to obtain the image features, and inputting the image features into the fully connected layer to finally output the estimated weight.

7. The method according to claim 1, wherein in the step S4, the body size data comprises: a shoulder width, a hip width, and a body length, and the body size data is calculated according to a distance between the keypoints.

8. The method according to claim 1, wherein in the step S3, the correcting is to correct the slanted pig with a minimum circumscribed rectangle.

9. The method according to claim 1, wherein in the step S4, the body size data and the weight data of the pig are bound with an identity of the pig and stored after being estimated, and the identity of the pig is obtained by recognizing back features of the pig in the images.

10. The method according to claim 4, wherein the weight estimation model comprises a loss function, and the loss function uses a root mean square error function.
